(19) United States
(12) Patent Application Publication
(10) Pub. No.: US 2015/0158040 A1
(43) Pub. Date: Jun. 11, 2015

(54) Inflatable bounce structure with foam generating system

(71) Applicant: Round House Racing, LLC, Spanish Fork, UT (US)

(72) Inventor: Jacob Ballard, Orem, UT (US)

(73) Assignee: ROUND HOUSE RACING, LLC, Spanish Fork, UT (US)

(21) Appl. No.: 14/099,959

(22) Filed: Dec. 8, 2013

(51) Int. Cl. B05B 7/24; A63G 31/12

(52) U.S. Cl. CPC B05B 7/2443; A63G 31/12

(57) ABSTRACT

The invention is directed toward a system and method for generating foam on an inflatable bounce structure. The system comprises a foaming solution reservoir, a nozzle, a foaming solution supply line, an electric liquid pump, and a dispersion unit. The foaming solution reservoir contains a foaming solution. The nozzle atomizes a foaming solution. The foaming solution supply line is connected to the foaming solution reservoir and the nozzle. The electric liquid pump delivers foaming solution from the foaming solution reservoir to the nozzle. The dispersion unit is embedded in the wall of an inflatable bounce structure. The nozzle sprays the atomized foaming solution on the dispersion unit. The air within the inflatable bounce structure passes through the dispersion unit to create a foam.

### TECHNICAL FIELD

The invention relates generally to inflatable bounce structures and bounce houses and more particularly to a system and method for generating foam in a recreational bounce structure.

### BACKGROUND OF THE INVENTION

Inflatable bounce structures are commonly used in many recreational environments, such as county fairs, street parties. These devices are generally in standard shapes, such as a castle or playroom. In addition, some inflatable bounce structures are constructed not as enclosed structures, but as linear obstacle courses, or as slides. Inflatable bounce structures are formed from vinyl that is sewn together in the predetermined shape. The inflatable bounce structures are filled with a continuous air stream which is provided by an electric fan. This continuous stream of air maintains the inflation of the structure and response of the surfaces during use. Users primarily enjoy the use of the inflatable structures by jumping and bouncing off of the surfaces without risk of injury. Historically, these structures have been used in large interior spaces. These structures have also been used in open exterior spaces such as fairs and carnivals. All use of these structures historically has been used in a dry setting, without the addition of liquids.

An additional enjoyable recreational activity by users is to play in soap foam. This activity starts at a young age when children play in bubble bath. More recently, foam machines have been developed which generate mass amounts of soap bubbles from a soap solution. Users can enjoy playing in the foam generated by these devices by running and sliding through the foam. Users normally engage in this activity in outdoor spaces, sometimes employing the use of a vinyl tarp on which to place the foam.

It stands to reason that inflatable bounce structures would be more enjoyable and more useful in certain situations by employing the use of foam. What is needed is a device and method for generating foam in or on an inflatable bounce structure in a safe and efficient manner in order to provide a novel bounce and recreational experience.

### SUMMARY OF THE INVENTION

The invention is directed toward a system and method for generating foam on an inflatable bounce structure. The system for generating foam on an inflatable bounce structure comprises a foaming solution reservoir, a nozzle, a foaming solution supply line, an electric liquid pump, and a dispersion unit. The foaming solution reservoir contains a foaming solution, with the foaming solution containing a surfactant. The nozzle atomizes a foaming solution. The foaming solution supply line has a first end and a second end. The first end of the foaming solution supply line is connected to the foaming solution reservoir and the second end of the foaming solution supply line is connected to the nozzle. The electric liquid pump delivers foaming solution from the foaming solution reservoir to the nozzle. The dispersion unit is embedded in the wall of an inflatable bounce structure. The nozzle sprays the atomized foaming solution on the dispersion unit. The air within the inflatable bounce structure passes through the dispersion unit to create a foam.

In another embodiment of the invention the foaming liquid supply line is removably secured to an inflatable bounce structure. Furthermore, the electric liquid pump may be variable in speed. The device may further comprise two or more nozzles and two or more dispersion units. Each nozzle sprays an atomized foaming solution on a respective dispersion unit and is connected to the foaming solution reservoir by a foaming solution supply line. Each dispersion unit is embedded in the wall of an inflatable bounce structure. The air within the inflatable bounce structure passes through each dispersion unit to create a foam. In each embodiment of the invention the dispersion unit may be fabric, wire mesh, or a synthetic foam pad.

The invention is also directed toward an inflatable bounce structure with a foam generator that comprises an inflatable bounce structure, an electric fan, a foaming solution reservoir, a nozzle, a foaming solution supply line, an electric liquid pump, and a dispersion unit. The inflatable bounce structure defines an enclosed space having an air inlet and one or more air outlets. The electric fan provides a continuous air stream into the air inlet. The foaming solution reservoir containing a foaming solution, with the foaming solution containing a surfactant. The nozzle atomizes a foaming solution. The foaming solution supply line has a first end and a second end. The first end of the foaming solution supply line is connected to the foaming solution reservoir and the second end of the foaming solution supply line is connected to the nozzle. The electric liquid pump delivers foaming solution from the foaming solution reservoir to the nozzle. The dispersion unit is embedded in the wall of an inflatable bounce structure. The nozzle sprays the atomized foaming solution on the dispersion unit. The air within the inflatable bounce structure passes through the dispersion unit to create a foam. In another embodiment of the invention the foaming solution supply line is housed within the internal air cavity of the inflatable bounce structure.

The inflatable bounce structure may further comprise a means for removably securing the liquid supply line to the inflatable bounce structure. In this embodiment the inflatable bounce structure may be formed as a slide. This embodiment may further comprise an extended member of the inflatable bounce structure. The dispersion unit is embedded in the wall of the extended member. Alternatively, this embodiment may further comprise a plurality of extended vertical members and a plurality of extended horizontal members. The extended vertical members are connected to the inflatable bounce structure. The extended horizontal members are connected to the extended vertical members. The extended vertical members and the extended horizontal members share an internal air source with the inflatable bounce structure. This embodiment may further comprise two or more nozzles and two or more dispersion units. Each nozzle sprays an atomized foaming solution on a respective dispersion unit and is connected to the foaming solution reservoir by a foaming solution supply line. Each dispersion unit is embedded in the wall of the inflatable bounce structure. The air within the inflatable bounce structure passes through each dispersion unit to create a foam. In each embodiment the dispersion unit may be fabric, wire mesh, or a synthetic foam pad.

The invention is also directed toward a method for generating foam on an inflatable bounce structure. The method comprises removably securing a foaming solution supply line to an inflatable bounce structure, providing a foaming solution to the foaming solution reservoir, pumping the foaming solution through the foaming solution supply line, spraying the foaming solution on a dispersion unit, and passing air through the dispersion unit from the internal air cavity of the inflatable bounce structure to external of the inflatable bounce structure. The foaming solution supply line has a first end and a second end. The first end of the foaming solution supply line is connected to the foaming solution reservoir and the second end of the foaming solution supply line is connected to the nozzle. The foaming solution contains a surfactant. The dispersion unit permits the through flow of air. The dispersion unit is embedded in the wall of the inflatable bounce structure.

In another embodiment of the invention, the method further comprises spraying the foaming solution on two or more dispersion units and passing air through the two or more dispersion units. Furthermore, the dispersion units may be a wire mesh.

### BRIEF DESCRIPTION OF THE DRAWINGS

FIG. 1 is a side view of the inflatable structure with foam generator

FIG. 2 is a detailed view of the dispersion unit

FIG. 3 is a side view of an embodiment of the invention where the dispersion units are housed within an extended member of the inflatable structure

FIG. 4 is a perspective view of an embodiment of the invention where the inflatable structure is an enclosed bounce house

FIG. 5 is a side view of another embodiment of the inflatable structure

FIG. 6 is a perspective view of the invention where the inflatable structure is a slide

### DETAILED DESCRIPTION OF THE DRAWINGS

Although the present invention will be described with reference to the exemplary embodiments shown in the drawings, it should be understood that the present invention can be embodied in many alternate forms or embodiments.

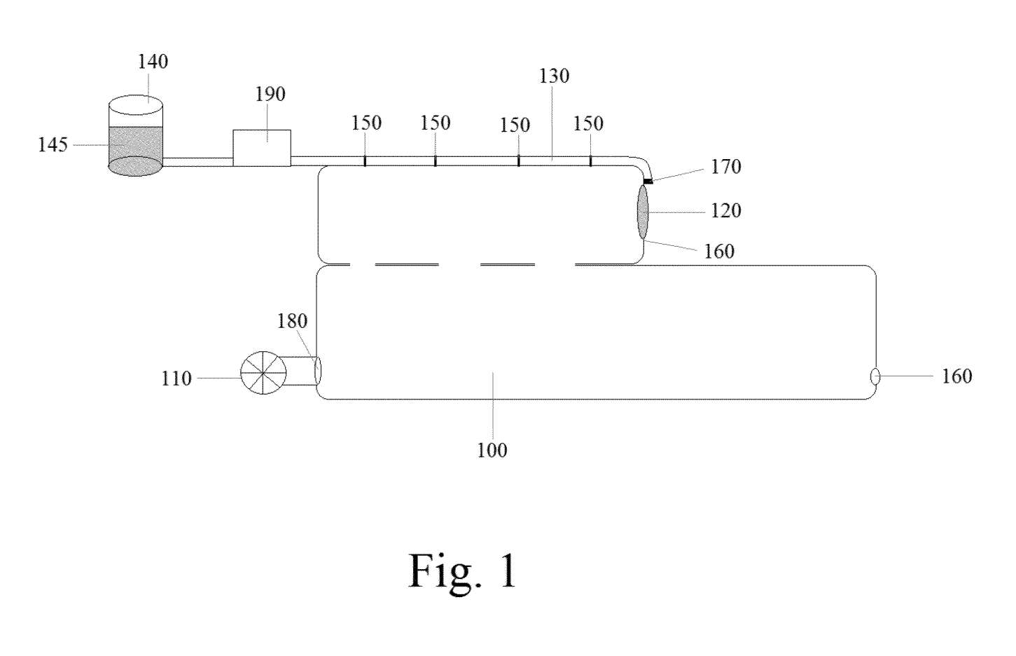

Referring to FIG. 1, the invention is directed toward an inflatable bounce structure 100 incorporating a foam generation system. The inflatable bounce structure 100 can be formed into any shape or structure intended for use as a physical recreational item. The inflatable bounce structure 100 can be made of any type of material intended for use on an inflatable bounce structure 100. In the most common embodiment, the inflatable bounce structure 100 is formed from vinyl. The inflatable bounce structure 100 may also be formed from any durable synthetic material. The inflatable bounce structure has an air inlet 180 which is removably connected to an electric fan 110. When turned on, the electric fan 110 pushes air through the air inlet 180 to inflate the inflatable bounce structure 100. The inflatable bounce structure may have an air outlet 160. The air outlet 160 restricts the flow of air through the inflatable bounce structure 100 such that a predetermined volume of air builds up within the inflatable bounce structure 100 and the internal air pressure of the inflatable bounce structure 100 becomes greater than the external atmospheric pressure. The inflatable bounce structure 100 may have one or more air outlets 160. In the air outlet 160 may be placed a dispersion unit 120. The dispersion unit 120 is structured to generate foam on the external surface of the inflatable bounce structure 100. The dispersion unit 120 generates foam through the foam generation system. The foam generation system utilizes a foaming solution 145. The foaming solution 145 is a liquid which generates bubbles when agitated and infused with air. The foaming solution 145 resides in a foaming solution reservoir 140. An electric liquid pump 190 pumps the foaming solution through a foaming solution supply line 130 to the dispersion unit 120. The foaming solution supply line is removably secured to the inflatable bounce structure by a securing means 150.

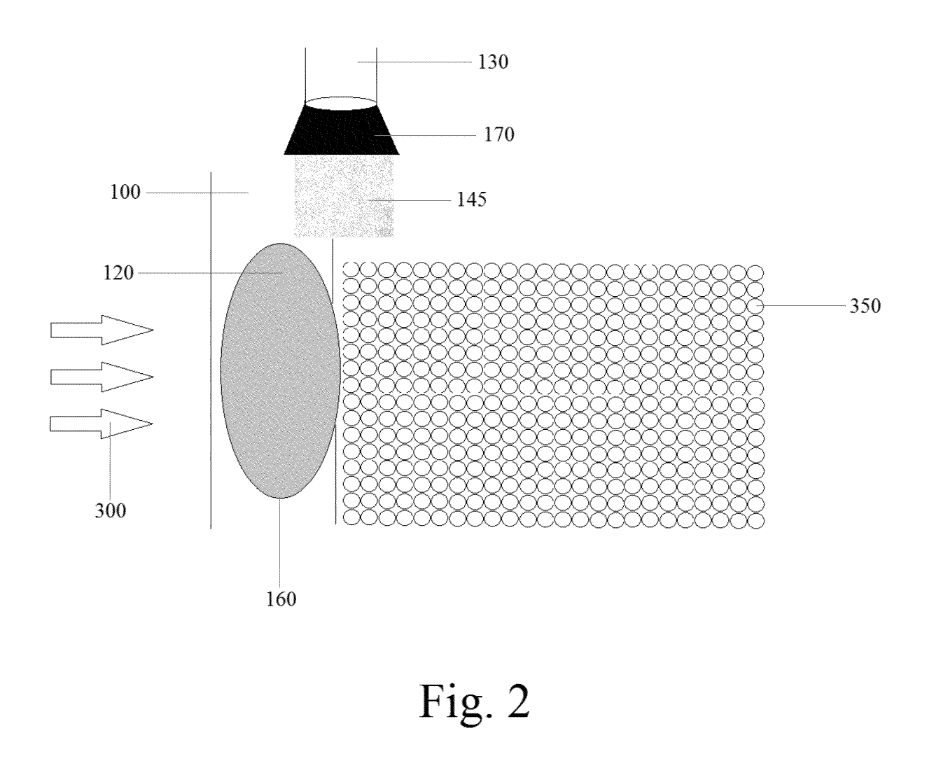

Referring to FIG. 2, the foaming solution supply line terminates into a nozzle 170. The foaming solution 145 is pumped through the foaming solution supply line 130 to the nozzle 170. The nozzle 170 atomizes the foaming solution, spraying a mist of the foaming solution onto the dispersion unit 120. The dispersion unit is embedded within an air outlet 160 in the wall of the inflatable bounce structure 100. The dispersion unit 120 may be any type of material structured to receive the foaming solution 145 while also permitting the outflow of air. The dispersion unit 120 may be formed from cloth, wire mesh, synthetic foam, sponge, or any other porous material. The dispersion unit 120 is structured to receive the foaming solution 145 such that the foaming solution 145 covers the surface area of the dispersion unit 120 and the voids in the dispersion unit 120 which permit the flow through of air. As the outward air flow 300 passes through the dispersion unit 120, the foaming solution 145 is agitated and pushed off of the dispersion unit 120. The surface tension of the foaming solution 145 is sufficient to permit the foaming solution 145 to form bubbles when agitated with air. The outward air flow 300 interacts with the foaming solution 145 on the dispersion unit to form a foam 350. The foam 350 is a mass of air bubbles within the foaming solution 145. The foaming solution supply line 130 and nozzle 170 present a substantially continuous stream of foaming solution 145 onto the dispersion unit to replace the foaming solution 145 which is removed from the dispersion unit 120 by the outward air flow 300. In other embodiments of the invention, the dispersion unit 120 may be supplied with foaming solution by two or more nozzles 170 to ensure complete coverage of the dispersion unit 120 with foaming solution 145.

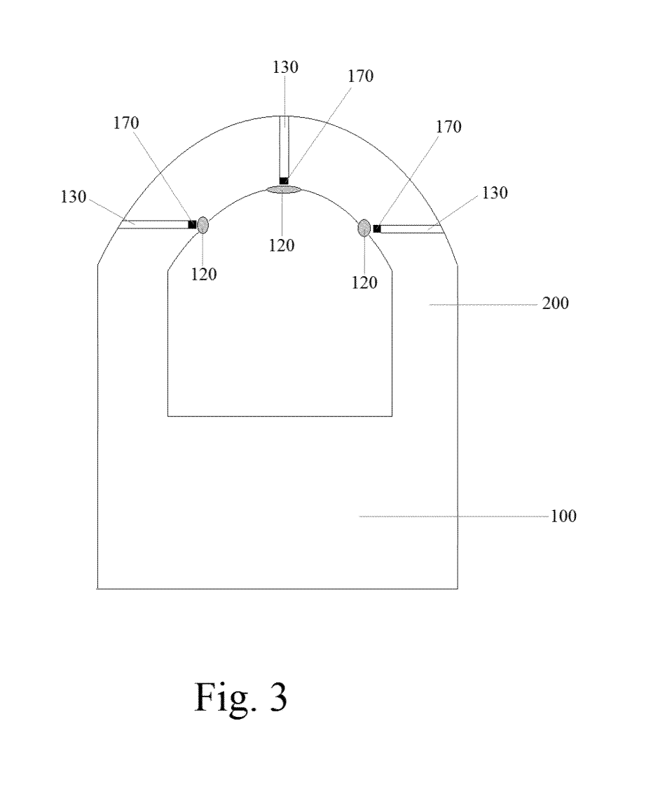

Referring to FIG. 3, an alternative embodiment of the invention is displayed. In this embodiment, the inflatable bounce structure 100 has an extended member 200. The extended member 200 may be of any size or shape. The extended member 200 is comprised of the same material as the inflatable bounce structure 100. The extended member 200 may be constructed to receive a continuous flow of air from the inflatable bounce structure 100 or may have its own electric fan 110 to provide for its own inflation air source. In the embodiment displayed, the extended member 200 is in the form of an arch with the base of the arch connected to the inflatable bounce structure 100. The extended member 200 houses the dispersion unit 120. In addition, the extended member may house a plethora dispersion units 120. Each dispersion unit is supplied with foaming solution 145 by a foaming solution supply line 130. Each foaming solution supply line 130 terminates in a nozzle 170. Each nozzle 170 atomizes the foaming solution 145 and sprays the foaming solution 145 onto the respective dispersion unit 120.

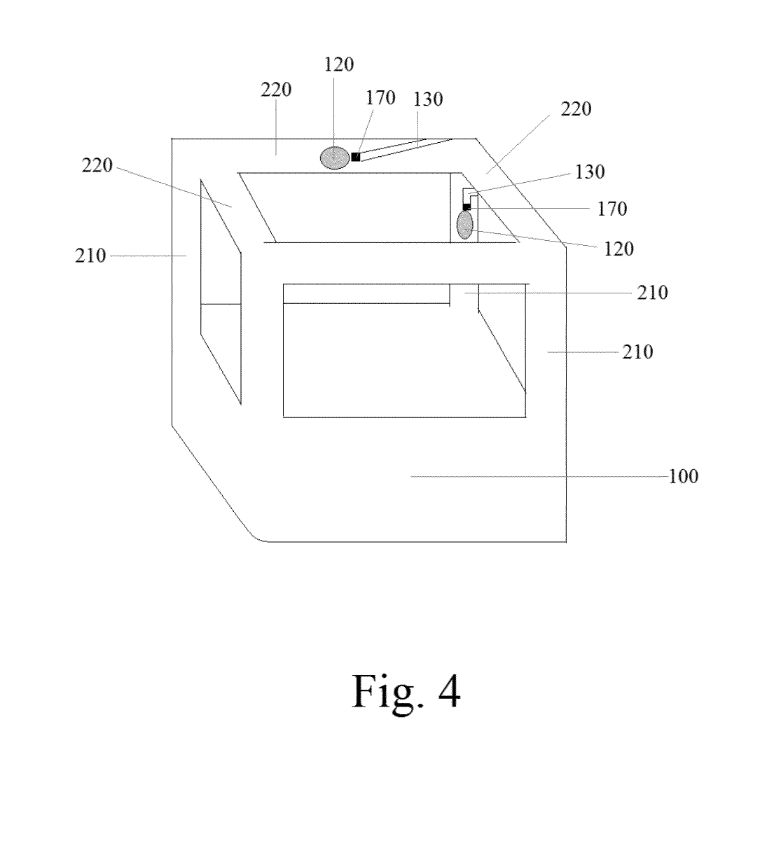

Referring to FIG. 4, an alternative embodiment of the invention is displayed. In this embodiment the inflatable bounce structure 100 contains a plurality of extended vertical members 210 and a plurality of extended horizontal members 220. The extended vertical members 210 are column-like extensions of the inflatable bounce structure 100. The extended horizontal members 220 are connected to the ends of the vertical extended members 210 distal from the inflatable bounce structure 100. One or more of the vertical extended members 210 may contain one or more dispersion units 120. One or more of the horizontal extended members 220 may contain one or more dispersion units 120.

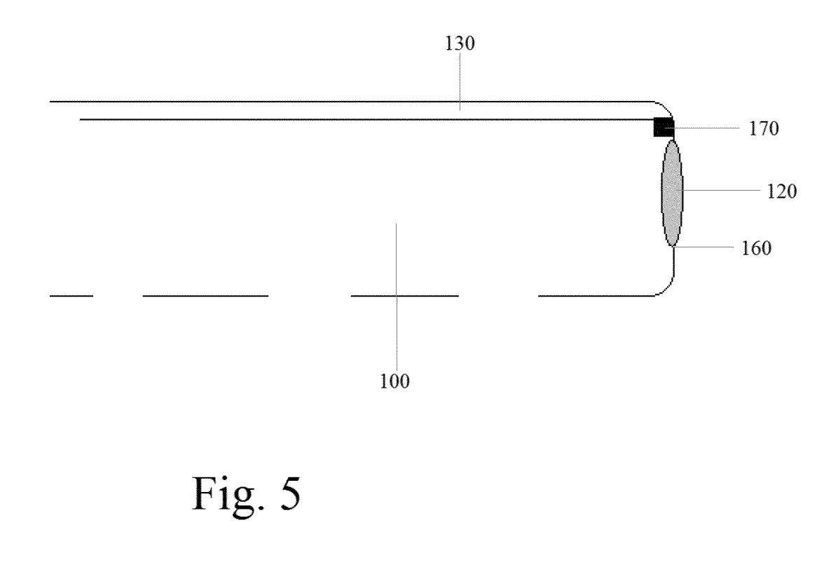

Referring to FIG. 5, the foaming solution supply line 130 may be presented in separate embodiments. FIG. 1 displays the foaming solution supply line in its preferred embodiment. In this embodiment, the foaming solution supply line 130 may be any type of hose or other device designed to carry fluid without leakage. The foaming solution supply line 130 may be constructed from rubber, vinyl, or synthetic rubber. In the preferred embodiment the foaming solution supply line 130 is removably secured to the inflatable structure 100 by a securing means 150. The securing means 150 may be any type of strap or device designed to affix to itself to secure the foaming solution supply line 130. The securing means may be hook and loop straps. The securing means 150 may be lengths of rope, lengths of woven fabric, or strips or any other type of material which may be manually tied together. Alternatively the securing means 150 may be bungee cords. The securing means 150 may be utilized by tying or securing two straps together over top of the foaming solution supply line 130. Alternatively the securing means may be preformed loops of material through which the foaming solution supply line 130 is threaded. The foaming solution supply line 130 may be wholly external from the inflatable bounce structure 100. As shown in FIG. 5, the foaming solution supply line 130 may be within the internal pressurized space of the inflatable bounce structure 100. The foaming solution supply line may be a void within the wall of the inflatable bounce structure 100. Alternatively portions of the foaming solution supply line 130 may pass through the walls of the inflatable bounce structure 100. Regardless of the form of the embodiment of the foaming solution supply line 130, the foaming solution supply line terminates into a nozzle 170 which atomizes the foaming solution 145 and sprays the foaming solution 145 onto the dispersion unit 120.

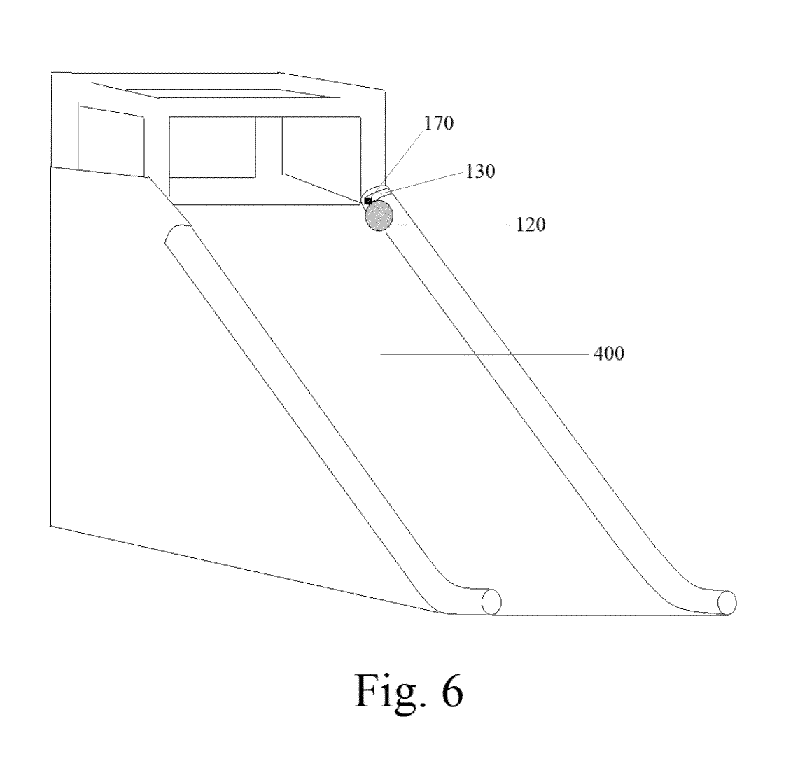

Referring to FIG. 6, the inflatable bounce structure 100 may be formed in any size and shape. In the embodiment displayed, the inflatable bounce structure 100 is formed as a slide with a sliding surface 400. In this embodiment the dispersion unit 120 is at the top of the slide permitting a user to slide through foam 350 on the sliding surface 400. The foam 350 lowers the surface friction of the sliding surface 400 permitting a user to slide down the sliding surface 400 at an increased velocity.

1. A system for generating foam on an inflatable bounce structure comprising
A foaming solution reservoir
Said foaming solution reservoir containing a foaming solution
Said foaming solution containing a surfactant
A nozzle
Wherein said nozzle atomizes a foaming solution
A foaming solution supply line
said foaming solution supply line having a first end and a second end
said first end of said foaming solution supply line connected to said foaming solution reservoir
said second end of said foaming solution supply line connected to said nozzle
An electric liquid pump
Wherein said electric liquid pump delivers foaming solution from said foaming solution reservoir to said nozzle
A dispersion unit
Wherein said dispersion unit is embedded in the wall of an inflatable bounce structure
Wherein said nozzle sprays said atomized foaming solution on said dispersion unit
Wherein the air within said inflatable bounce structure passes through said dispersion unit to create a foam.

2. The device as in claim 1
Wherein said foaming liquid supply line is removably secured to an inflatable bounce structure.

3. The device as in claim 2
Wherein said electric liquid pump is variable in speed.

4. The device as in claim 3 further comprising
Two or more nozzles
Wherein each nozzle sprays an atomized foaming solution on a respective dispersion unit
Wherein each nozzle is connected to said foaming solution reservoir by a foaming solution supply line
Two or more dispersion units
Wherein each dispersion unit is embedded in the wall of an inflatable bounce structure
Wherein the air within said inflatable bounce structure passes through said dispersion unit to create a foam.

5. The device as in claim 3
Wherein the dispersion unit is fabric.

6. The device as in claim 3
Wherein the dispersion unit is wire mesh.

7. The device as in claim 3
Wherein the dispersion unit is a synthetic foam pad.

8. An inflatable bounce structure with a foam generator comprising
An inflatable bounce structure
Said inflatable bounce structure defining an enclosed space having an air inlet and one or more air outlets
An electric fan
Said electric fan providing a continuous air stream into said air inlet
A foaming solution reservoir
Said foaming solution reservoir containing a foaming solution
Said foaming solution containing a surfactant
A nozzle
Wherein said nozzle atomizes said foaming solution
A foaming solution supply line
said foaming solution supply line having a first end and a second end
said first end of said foaming solution supply line connected to said foaming solution reservoir
said second end of said foaming solution supply line connected to said nozzle
An electric liquid pump
Wherein said electric liquid pump delivers foaming solution from said foaming solution reservoir to said nozzle
A dispersion unit
Wherein said dispersion unit is embedded in the wall of said inflatable bounce structure
Wherein said nozzle sprays said atomized foaming solution on said dispersion unit
Wherein the air within said inflatable bounce structure passes through said dispersion unit to create a foam.

9. The inflatable bounce structure as in claim 8 further comprising
A means for removably securing said liquid supply line to said inflatable bounce structure.

10. The inflatable bounce structure as in claim 9
Wherein said inflatable bounce structure is formed as a slide.

11. The inflatable bounce structure as in claim 9 further comprising
An extended member of said inflatable bounce structure
Wherein said dispersion unit is embedded in the wall of said extended member.

12. The inflatable bounce structure as in claim 9 further comprising
A plurality of extended vertical members
Wherein said extended vertical members are connected to said inflatable bounce structure
A plurality of extended horizontal members
Wherein said extended horizontal members are connected to said extended vertical members
Wherein said extended vertical members and said extended horizontal members share an internal air source with said inflatable bounce structure.

13. The inflatable bounce structure as in claim 12 further comprising
Two or more nozzles
Wherein each nozzle sprays an atomized foaming solution on a respective dispersion unit
Wherein each nozzle is connected to said foaming solution reservoir by a foaming solution supply line
Two or more dispersion units
Wherein each dispersion unit is embedded in the wall of said inflatable bounce structure
Wherein the air within said inflatable bounce structure passes through each dispersion unit to create a foam.

14. The inflatable bounce structure as in claim 9
Wherein each dispersion unit is fabric.

15. The inflatable bounce structure as in claim 9
Wherein each dispersion unit is wire mesh.

16. The inflatable bounce structure as in claim 9
Wherein each dispersion unit is a synthetic foam pad.

17. The inflatable bounce structure as in claim 8
Wherein said foaming solution supply line is housed within the internal air cavity of said inflatable bounce structure.

18. A method for generating foam on an inflatable bounce structure comprising
Removably securing a foaming solution supply line to an inflatable bounce structure
said foaming solution supply line having a first end and a second end
said first end of said foaming solution supply line connected to said foaming solution reservoir
said second end of said foaming solution supply line connected to said nozzle
Providing a foaming solution to said foaming solution reservoir
Said foaming solution containing a surfactant
Pumping said foaming solution through said foaming solution supply line
Spraying said foaming solution on a dispersion unit
Said dispersion unit permitting the through flow of air
Said dispersion unit embedded in the wall of said inflatable bounce structure
Passing air through said dispersion unit from the internal air cavity of said inflatable bounce structure to external of said inflatable bounce structure.

19. The method as in claim 18 further comprising
Spraying said foaming solution on two or more dispersion units
Passing air through said two or more dispersion units.

20. The method as in claim 19
Wherein said dispersion units are wire mesh.
